(19) United States
(12) Patent Application Publication
(10) Pub. No.: US 2009/0233692 A1
(43) Pub. Date: Sep. 17, 2009

(54) Slot Machine

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/402,200

(22) Filed: Mar. 11, 2009

Related U.S. Application Data
(60) Provisional application No. 61/035,604, filed on Mar. 11, 2008.

(51) Int. Cl. A63F 9/24; A63F 13/00

(52) U.S. Cl. 463/20; 463/30; 463/25

(57) ABSTRACT

Each payout amount display frame Q1, Q2 and Q3 is superimposed in each symbol display frame W1, W2 and W3 of a liquid crystal panel 5B. When a payout trigger symbol is rearranged in each of the symbol display frames W1, W2 and W3 in a slot game, an image of each mini reel M1, M2 and M3 being rotated and stopped is displayed in each of the payout amount display frames Q1, Q2 and Q3 after a predetermined time has passed. Accordingly, a payout amount drawn on a reel band of each mini reel M1, M2 and M3 is rearranged in each of the payout amount display frames Q1, Q2 and Q3. An amount obtained by multiplying a total amount of the rearranged payout amounts by the bet amount is awarded to a player. Each of the rearranged payout amounts is displayed being enlarged.

### CROSS-REFERENCE TO RELATED APPLICATIONS

This application is based upon and claims a priority from the U.S. Provisional Patent Application No. 61/035,604 filed on Mar. 11, 2008, the entire contents of which are incorporated herein by reference.

### BACKGROUND

1. Field of the Invention

The present invention relates to a slot machine having a reel which displays the payout amount.

2. Description of Related Art

As is disclosed in US Patent 2005/0250577A1, for example, conventionally, there has been a slot machine having a rotating wheel which displays the payout amount.

When a predetermined condition is met in a slot game, the rotating wheel is rotated and stopped so as to display the payout amount which will be awarded to a player. The rotating wheel is provided separately from a reel which is used for the slot game.

Therefore, rotation and stop of the rotating wheel is performed when the slot game is performed. In other words, the rotation and stop of the rotating wheel does not affect a process of the slot game.

### SUMMARY

The present invention has been conceived in view of the above circumstance and the object of the present invention is to provide an unprecedented novel slot machine in which a reel for displaying a payout amount and a reel used for a slot game are combined.

To achieve the object of the present invention, there is provided a slot machine comprising: a plurality of payout trigger symbols; a plurality of symbols including the payout trigger symbols; a symbol group comprising the symbols; a plurality of symbol frames in each of which one of the symbols is arranged; a display device for displaying each of the symbol frames; a plurality of payout amount frames being superimposed on a part of each of the symbol frames which is displayed on the display device, a payout amount being arranged in each of the payout amount frames; a unit game in which a payout amount is awarded to a player when all the symbols displayed on the display device are the payout trigger symbols; an input device with which a player performs a betting operation for the unit game; and a processor programmed, for repeating the unit game repeatedly, to execute each of processes from the process of (1) below to the process of (7) below: (1) selecting some of the symbols at random from the symbol group upon completing a betting operation for a current unit game by a player using the input device; (2) displaying on the display device each of the selected symbols being rearranged in each of the symbol frames; (3) determining whether all the symbols displayed on the display device are the payout trigger symbols or not; (4) returning to the process of (1) if it is determined that not all the symbols displayed on the display device are the payout trigger symbols; (5) rearranging each payout amount in each of the payout amount frames if it is determined that all the symbols displayed on the display device are the payout trigger symbols; (6) enlarging a size of each payout amount rearranged in each of the payout amount frames to a size of each of the symbol frames and displaying each of the enlarged payout amount on the display device; and (7) awarding a total amount of the payout amounts that are rearranged in the payout amount frames to the player and returning to the process of (1).

Furthermore, according to another aspect of the present invention, there is provided a slot machine, comprising: a plurality of payout trigger symbols; a plurality of symbols including the payout trigger symbols; a symbol group comprising the symbols; a plurality of symbol frames in each of which one of the symbols is arranged; a display device for displaying each of the symbol frames; a plurality of payout amount frames being superimposed on a part of each of the symbol frames which is displayed on the display device, a payout amount being arranged in each of the payout amount frames; a unit game in which a payout amount is awarded to a player when all the symbols displayed on the display device are the payout trigger symbols; an input device with which a player performs a betting operation for the unit game; and a processor programmed, for repeating the unit game repeatedly, to execute each of processes from the process of (1) below to the process of (7) below: (1) selecting some of the symbols at random from the symbol group upon completing a betting operation for a current unit game by a player using the input device; (2) displaying on the display device each of the selected symbols being rearranged in each of the symbol frames and rearranging each payout amount in each of the payout amount frames; (3) determining whether all the symbols displayed on the display device are the payout trigger symbols or not; (4) returning to the process of (1) if it is determined that not all the symbols displayed on the display device are the payout trigger symbols; (5) enlarging a size of each payout amount rearranged in each of the payout amount frames to a size of each of the symbol frames and displaying each of the enlarged payout amount on the display device if it is determined that all the symbols displayed on the display device are the payout trigger symbols; and (6) awarding a total amount of the payout amounts that are rearranged in the payout amount frames to the player and returning to the process of (1).

### BRIEF DESCRIPTION OF THE DRAWINGS

FIG. 1 is a view showing characteristics of a slot machine which is one embodiment of the present invention;

FIG. 2 is a perspective view of the slot machine;

FIG. 3 is a schematic view showing symbol columns drawn on reel band of each reel;

FIG. 4 is a schematic view showing payout amount columns drawn on reel band of each mini reel;

FIG. 5 is a block diagram showing an internal construction of entire slot machine;

FIG. 6 is a block diagram showing an internal construction of a sub control board;

FIG. 7 is a view showing one of an image displayed on a liquid crystal panel;

FIG. 8 is a view showing one of an image displayed on the liquid crystal panel;

FIG. 9 is a flowchart of a main control program;

FIG. 10 is a flowchart of a main game process program;

FIG. 11 is a flowchart of a unit game process program;

FIG. 12 is a view showing characteristics of a slot machine which is other embodiment of the present invention;

FIG. 13 is a flowchart of a unit game process program.

### DETAILED DESCRIPTION

### 1. Characteristics of the Present Invention

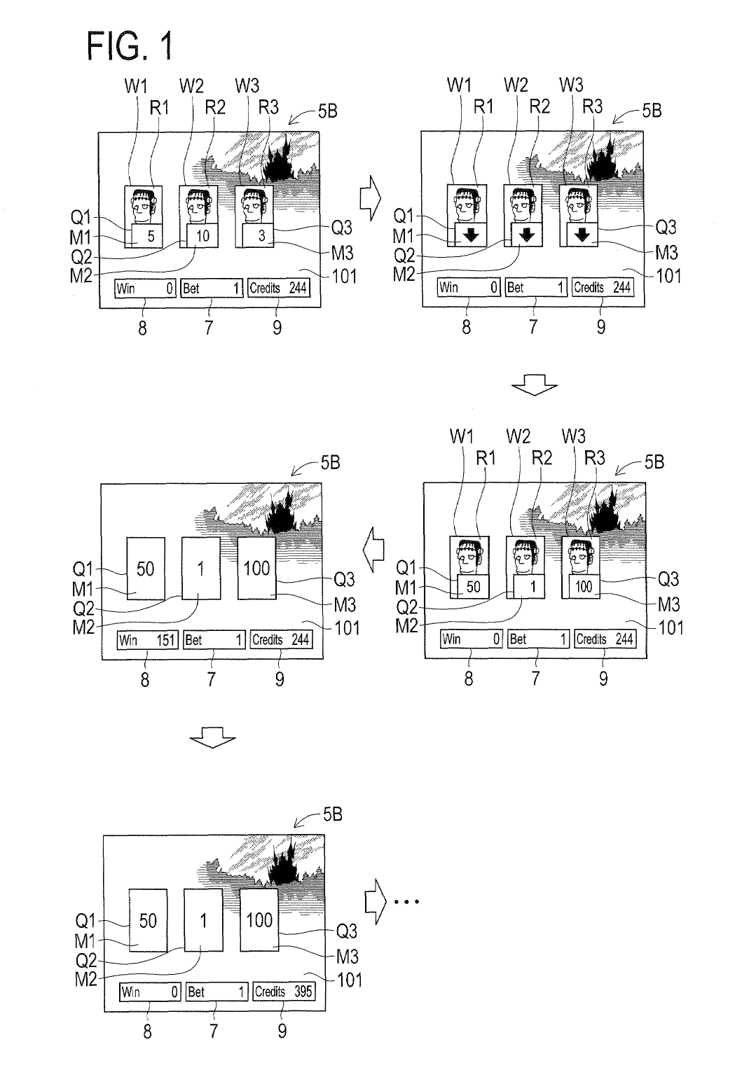

FIG. 1 is a view showing characteristics of a slot machine which is one embodiment of the present invention. Incidentally, the portion from the above will be described for specifying a state of a liquid crystal panel 5B in FIG. 1.

In the slot machine according to the present embodiment, a slot game attempting rearrangement of three payout trigger symbols is executed.

In the slot game, as shown in FIG. 1, symbol display frames W1, W2 and W3 arranging three symbols are displayed on the known liquid crystal panel 5B. In this respect, three video reels R1, R2 and R3 are assigned to three symbol display frames W1, W2 and W3, respectively. Therefore, one of symbols drawn on a reel band of each video reel R1, R2 and R3 is arranged in each of the symbol display frames W1, W2 and W3. Payout amount display frames Q1, Q2 and Q3 are superimposed on the symbol display frames W1, W2 and W3, respectively. In this respect, the three payout amount display frames Q1, Q2 and Q3 are assigned to three mini reels M1, M2 and M3, respectively. Therefore, one of payout amounts drawn on a reel band of each mini reel M1, M2 and M3 is arranged in each payout amount display frame Q1, Q2 and Q3. Incidentally, each mini reel M1, M2 and M3 is a kind of reel which is displayed on the liquid crystal panel 5B with video data. Further, the liquid crystal panel 5B has a bet amount display portion 7, a payout amount display portion 8 and a credit amount display portion 9. Incidentally, a touch panel 101 is provided on a front face of the liquid crystal panel 5B.

Namely, in this slot game, a slot game is executed such that the three video reels R1, R2 and R3 rearrange a symbol of “FRANKENSTEIN” which is the payout trigger symbol, in the symbol display frames W1, W2 and W3 of the liquid crystal panel 5B. When each video reel R1, R2 and R3 is rotated and stopped, one symbol is rearranged in each symbol display frame W1, W2 and W3, respectively.

When the symbol of “FRANKENSTEIN” is rearranged in each symbol display frame W1, W2 and W3 of the liquid crystal panels 5B shown on both sides in the upper stage of FIG. 1, each mini reel M1, M2, M3 is displayed by a scrolling manner in each payout amount display frame Q1, Q2 and Q3 after a predetermined time has passed.

After a predetermined time has further passed, each mini reel M1, M2 and M3 automatically is displayed by a stopped manner on the liquid crystal panel 5B shown on the right side in the middle stage of FIG. 1. Therefore, one of the payout amounts drawn on the reel band of each mini reel M1, M2 and M3 is rearranged in each payout amount display frame Q1, Q2 and Q3, respectively.

Then, as shown on the liquid crystal panel 5B shown on both sides in the middle stage of FIG. 1, each payout amount display frame Q1, Q2 and Q3 is displayed being enlarged to fit into a size of each symbol display frame W1, W2 and W3. Accordingly, the payout amount rearranged in each payout amount display frame Q1, Q2 and Q3 is displayed being enlarged.

Further, the total amount of the payout amounts that have been rearranged in the payout amount display frames Q1, Q2 and Q3 of the liquid crystal panel 5B is computed. As shown on the liquid crystal panel 5B shown on the left side in the middle stage of FIG. 1, the payout amount which is computed by multiplying the total amount by the bet amount which is indicated by a player is displayed in the payout amount display portion 8. With this, the computed payout amount is awarded to the player. Incidentally, the bet amount which is indicated by a player is displayed in the bet amount display portion 7. When the slot game is finished, the payout amount displayed in the payout amount display portion 8 is added to the amount in the credit amount display portion 9, and the added amount is displayed in the credit amount display portion 9, as shown on the liquid crystal panel 5B shown on the left side in the lower stage of FIG. 1.

With this, a unit game of a slot game is configured.

### 2. Construction of the Slot Machine

Hereinafter, the one embodiment embodying the present invention will be explained in detail with reference to the drawings.

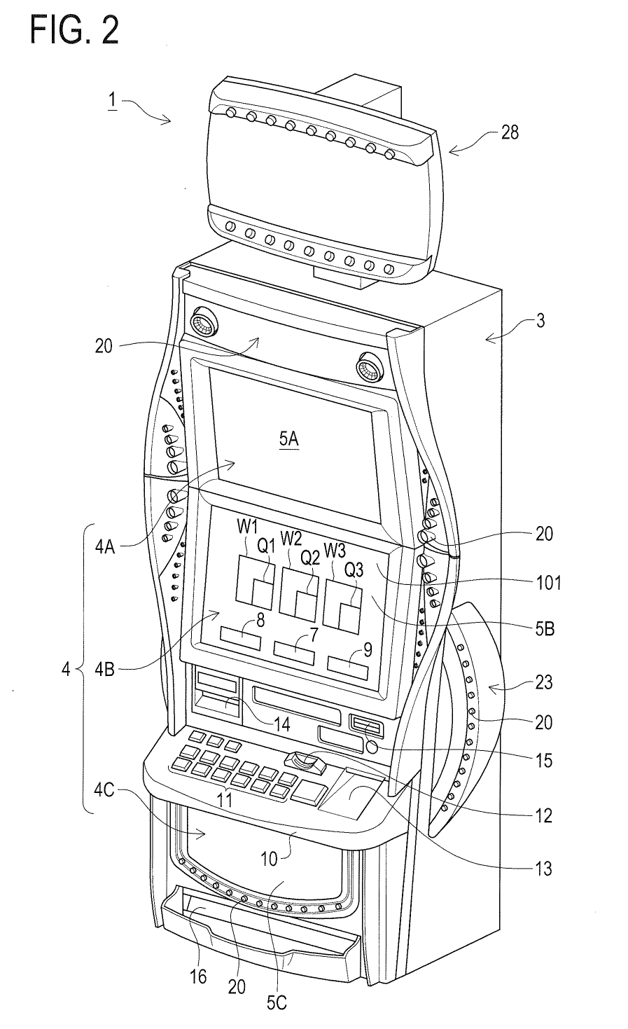

First, an outline construction of the slot machine 1 according to the present embodiment will be explained with reference to FIG. 2. FIG. 2 is a perspective view of the slot machine 1 according to the present embodiment.

As shown in FIG. 2, the slot machine 1 is an upright type slot machine arranged in a game arcade such as casino, in order to execute predetermined game modes, such slot machine includes a cabinet 3 in which electronic and mechanical components are installed. For example, as a display portion 4 to display information concerning a game, there are provided an upper display portion 4A, a middle variable display portion 4B and a lower display portion 4C. Each display portion 4A to 4C is mounted at the front of the oblong cabinet 3. The upper display portion 4A includes a liquid crystal panel 5A which is arranged above the middle variable display portion 4B. On the liquid crystal panel 5A, for example, an effect image, an introduction of a game content, and a rule explanation of a game are displayed. The lower display portion 4C is arranged below the middle variable display portion 4B, and includes a plastic panel 5C on which images are printed, and a plastic panel 5C is lightened by backlights.

The middle variable display portion 4B, which is used to display an execution state of a game, includes the liquid crystal panel 5B which is fixed at the front door of the cabinet 3. In this liquid crystal panel 5B, three symbols of the video reels are displayed by a scrolling manner and by a stopped manner, respectively. In the middle variable display portion 4B, the three symbol display frames W1, W2 and W3 corresponding to each video reel R1, R2 and R3 are displayed on the liquid crystal panel 5B. Further, in the middle variable display portion 4B, the three payout amount display frames Q1, Q2 and Q3 corresponding to each mini reel M1, M2 and M3 are displayed on the liquid crystal panel 5B. Each of the payout amount display frames Q1, Q2 and Q3 is superimposed on each corresponding symbol display frame W1, W2 and W3. Further, a touch panel 101 is provided on the front surface of the liquid crystal panel 5B. On the lower position of the middle variable display portion 4B, the bet amount display portion 7, the payout amount display portion 8 and the credit amount display portion 9 are arranged on the liquid crystal panel 5B. Also the upper portion of the middle variable display portion 4B, is related to the back side, thereby a player may play a game in a cozy posture.

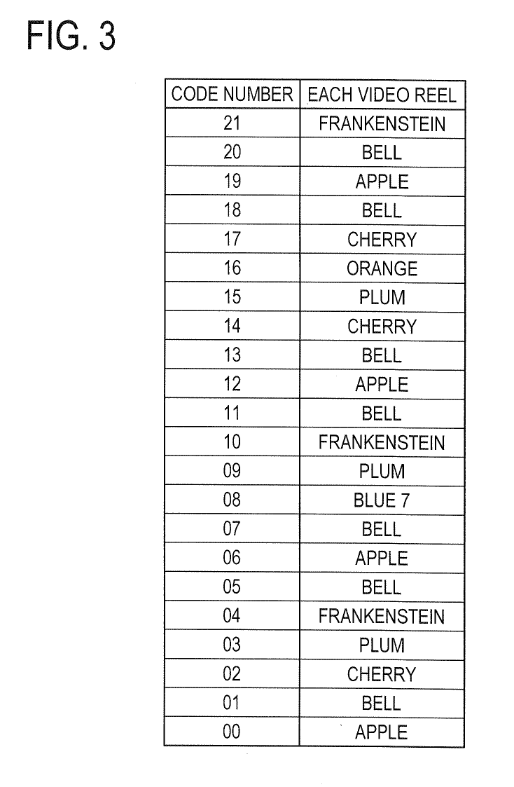

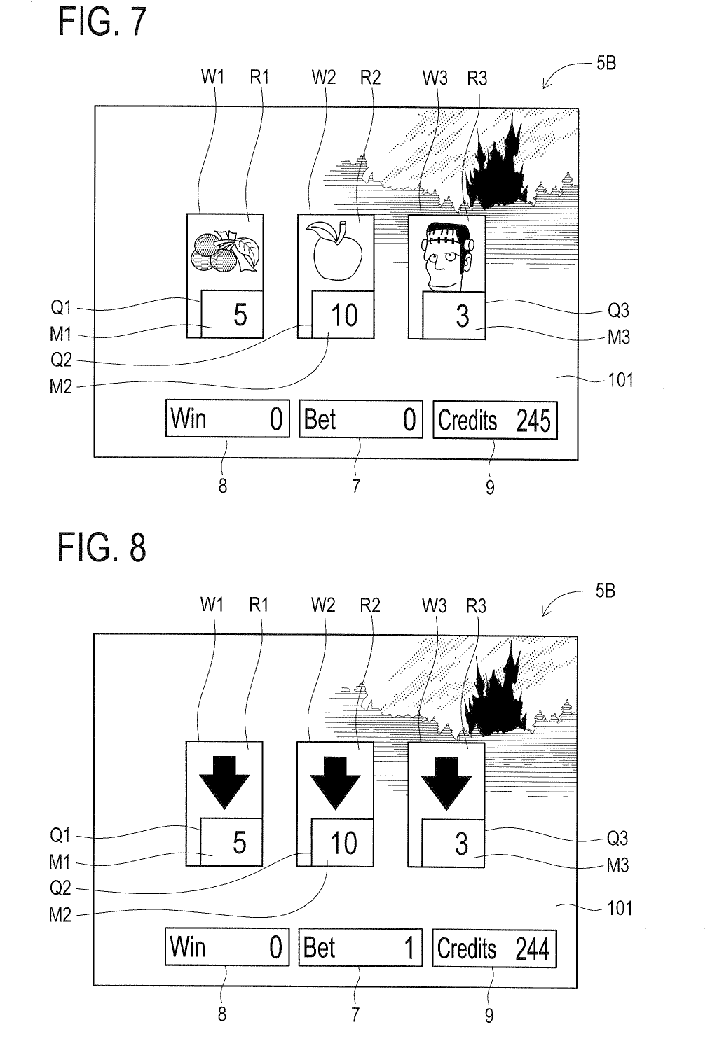

Now, images of a slot game to be displayed on the liquid crystal panel 5B are explained. FIG. 7 and FIG. 8 are drawings showing contents displayed on the liquid crystal panel 5B, as one example of images of a slot game to be displayed on the liquid crystal panel 5B. As shown in FIG. 7 and FIG. 8, on the liquid crystal panel 5B in a slot game, the symbol drawn on the reel band of each video reel R1, R2 and R3 is displayed in each symbol display frames W1, W2 and W3, so that they can be viewed by a player. FIG. 7 shows a state in which the symbol drawn on the reel band of each video reel R1, R2 and R3 is arranged or rearranged in each symbol display frames W1, W2 and W3 of the liquid crystal panel 5B. FIG. 8 shows a state in which the symbol drawn on the reel band of each video reel R1, R2 and R3 is displayed by a scrolling manner in each symbol display frames W1, W2 and W3 of the liquid crystal panel 5B. Incidentally, on the reel band of each video reel R1, R2 and R3, a symbol column constructed from twenty-two symbols is drawn respectively (refer to FIG. 3).

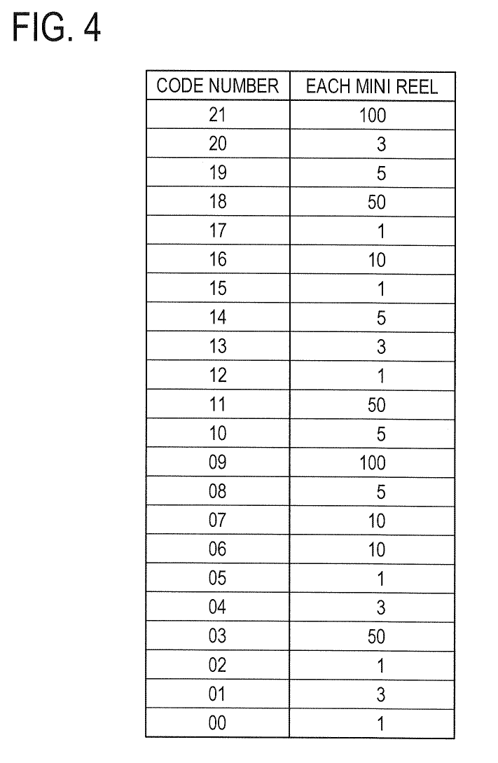

On the liquid crystal panel 5B, as shown in FIG. 7 and FIG. 8, the payout amount display frame Q1, Q2 and Q3 is superimposed on each corresponding symbol display frame W1, W2 and W3 while a slot game is executed. Further, the payout amount drawn on the reel band of each mini reel M1, M2 and M3 is displayed in each corresponding payout amount display frame Q1, Q2 and Q3, so that they can be viewed by a player. FIG. 7 and FIG. 8 show a state in which the payout amount drawn on the reel band of each mini reel M1, M2 and M3 is arranged or rearranged in each corresponding payout amount display frame Q1, Q2 and Q3 of the liquid crystal panel 5B. Incidentally, a column of the payout amounts including twenty-two payout amounts is drawn on the reel band of each mini reel M1, M2 and M3 (refer to FIG. 4).

As shown on the liquid crystal panel 5B shown on the right side in the upper stage of FIG. 1, the payout amount drawn on the reel band of each mini reel M1, M2 and M3 is displayed by a scrolling manner in each corresponding payout amount display frame Q1, Q2 and Q3, after the payout trigger symbol is rearranged in each symbol display frame W1, W2 and W3. Further, as shown on the liquid crystal panel 5B shown on both sides in the middle stage of FIG. 1, each payout amount display frame Q1, Q2 and Q3 is displayed being enlarged so as to be interposed on each corresponding symbol display frame W1, W2 and W3, after the payout amount is rearranged in each payout amount display frame Q1, Q2 and Q3. Accordingly, each payout amount displayed in the payout amount display frame Q1, Q2 and Q3 is displayed being enlarged.

Returning to FIG. 7 and FIG. 8, the bet amount display portion 7, the payout amount display portion 8 and the credit amount display portion 9 are arranged on the liquid crystal panel 5B. On the bet amount display portion 7, the bet amount which is indicated by the current player is displayed. On the payout amount display portion 8, the payout amount awarded in a slot game to a player is displayed. On the credit amount display portion 9, the credit amount which is owned by the current player is displayed.

Therefore, on the liquid crystal panel 5B in a slot game, one symbol which is drawn on the reel band of each video reel R1, R2 and R3 is arranged in each of the three symbol display frames W1, W2 and W3. In addition, one payout amount which is drawn on the reel band of each mini reel M1, M2 and M3 is arranged in each of the three payout amount display frames Q1, Q2 and Q3.

Returning to FIG. 2, between the middle variable display portion 4B and the lower display portion 4C, at the front of the cabinet 3, an operation table 10 which is projected forward is arranged. On the operation table 10, a variety of operation buttons 11 including a BET button, a collecting button, a spin button and a CASHOUT button are arranged as an operation portion to execute a game. On the operation table 10, a coin insertion slot 12 and a bill insertion slot 13 are arranged. Also between the operation table 10 and the middle variable display portion 4B, a ticket printer 14, a card reader 15 and a reader/writer 15 are arranged. At the lowest position of the cabinet 3, a coin tray 16 is also arranged.

Incidentally, in the slot machine 1 of the present embodiment, gaming medium may be coin, bill, or electronic value (credit). Here, the gaming medium may be others as well, such as medal, token, electronic money, or ticket.

Further, on the cabinet 3 of the slot machine 1, light emitting portions 20 are arranged around a game area including the upper display portion 4A, the middle variable display portion 4B, the lower display portion 4C and the operation table 10.

Furthermore, the slot machine 1 also includes a topper effect device 28 which is installed on the cabinet 3. The topper effect device 28 is shaped in a rectangular board shaped, and is arranged almost parallel to the liquid crystal panel 5A of the upper display portion 4A. The cabinet 3 is further provided with speakers 23 on its both sides.

### 3. Outline of Symbols

Next, the symbols drawn on the reel band of each video reel R1, R2 and R3 will be explained with reference to FIG. 3. These symbols are scrolled and rearranged in each symbol display frame W1, W2 and W3 of the liquid crystal panel 5B in a slot game. FIG. 3 is a schematic view showing symbol columns drawn on the reel band of each video reel R1, R2 and R3.

On the reel band of each video reel R1, R2 and R3, twenty-two symbols are arranged respectively. Each symbol column of video reel R1, R2 and R3 is constructed from the symbols including “FRANKENSTEIN”, “BLUE7”, “BELL”, “APPLE”, “CHERRY”, “ORANGE” and “PLUM”. And the symbols of predetermined types are arranged in a predetermined sequence. In other words, a symbol group is composed of each of the symbols of “FRANKENSTEIN”, “BLUE7”, “BELL”, “APPLE”, “CHERRY”, “ORANGE” and “PLUM”.

Incidentally, to each symbol composing the symbol column of each video reel R1, R2 and R3 shown in FIG. 3, a code number is allocated from top to down in sequence.

### 4. General Description of the Payout Amount

Subsequently, the payout amounts drawn on the reel band of each mini reel M1, M2 and M3 will be explained with reference to FIG. 4. These payout amounts are scrolled and rearranged in each payout amount display frame Q1, Q2 and Q3 of the liquid crystal panel 5B while a slot game is executed. FIG. 4 is a schematic view showing columns of the payout amounts drawn on the reel band of each mini reel M1, M2 and M3.

Each mini reel M1, M2 and M3 is a kind of reel which is displayed on the liquid crystal panel 5B with video data. Twenty-two payout amounts are drawn on the reel band of each mini reel M1, M2 and M3. The column of the payout amounts of each mini reel M1, M2 and M3 is comprised of a combination of the payout amounts including “100”, “50”, “10”, “5”, “3” and “1”. Predetermined kinds of payout amounts are positioned in a predetermined order.

In this respect, the total amount of the payout amounts which are rearranged in the payout amount display frames Q1, Q2 and Q3 of the liquid crystal panel 5B corresponds to the payout amount which is awarded to a player.

Incidentally, to each of the payout amount composing the column of the payout amounts of each mini reel M1, M2 and M3 shown in FIG. 4, a code number is allocated from top to down in sequence.

### 5. Internal Construction of the Slot Machine

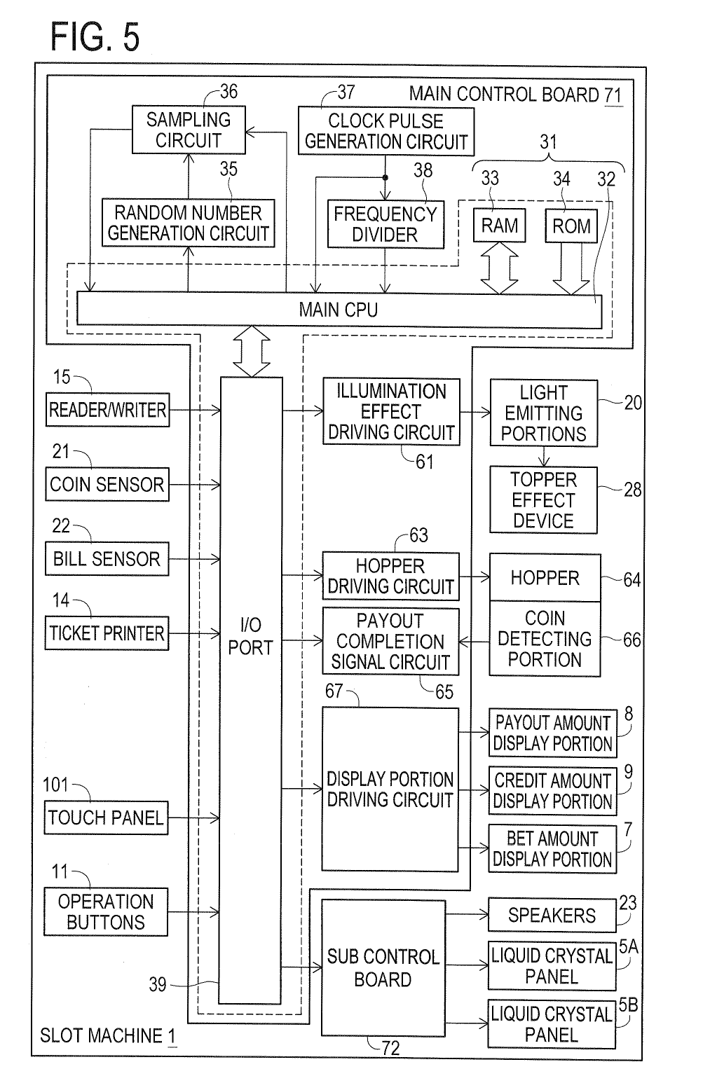

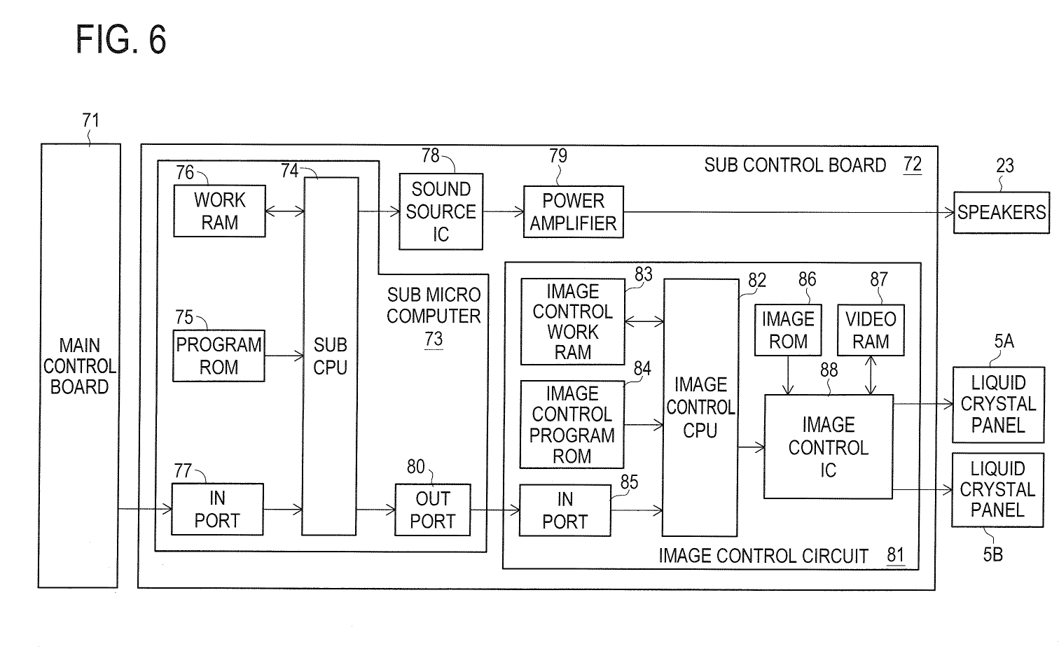

Next, an internal construction of the above slot machine 1 will be explained with reference to FIG. 5 and FIG. 6.

FIG. 5 is a block diagram showing an internal construction of entire slot machine 1. As shown in FIG. 5, the slot machine 1 includes a plurality of construction elements such as a main control board 71, in which a microcomputer 31 is included. The main control board 71 is constructed from the microcomputer 31, a random number generation circuit 35, a sampling circuit 36, a clock pulse generation circuit 37 and a frequency divider 38. The main control board 71 also includes an illumination effect driving circuit 61, a hopper driving circuit 63, a payout completion signal circuit 65 and a display portion driving circuit 67.

The microcomputer 31 is constructed from a main CPU 32, a RAM 33 and a ROM 34. The main CPU 32 runs based on programs stored in the ROM 34, and inputs/outputs a signal with other elements through an I/O port 39, so as to execute control of the entire slot machine 1. Data and programs used when the main CPU 32 runs are stored in the RAM 33. For example, after-mentioned random numbers which are sampled by the sampling circuit 36 are stored temporarily after a start of a game, also the code numbers of the respective video reels R1, R2 and R3 and the symbol numbers are stored in the RAM 33 and also the code numbers of the respective mini reel M1, M2 and M3 and the payout numbers are stored in the RAM 3. Programs executed by the main CPU 32 and permanent data are stored in the ROM 34.

Especially, the programs stored in the ROM 34 include game programs and game system programs (abbreviated as “the game programs and the like” hereinafter). Further, the first lottery programs mentioned below and the second lottery programs mentioned below are also included in the game programs.

The first lottery program is a program used to determine the code numbers of the respective video reels R1, R2 and R3 that correspond to each symbol rearranged in the respective symbol display frames W1, W2 and W3 of the liquid crystal panel 5B. Then, in the lottery program, it is included symbol weighing data corresponding to each of plural kinds of payout rates (for example, 80%, 84%, and 88%). The symbol weighing data are the data indicating correlation between the code number of each video reel R1, R2 and R3 and one or plural random numbers belonging to a predetermined number range (0 to 255), every each of the three video reels R1, R2 and R3. In other words, each of the code number of one video reel R1, R2 and R3 is associated with one or more random numbers corresponding to the payout rate. The random numbers are extracted by the lottery program, and symbols specified finally by the random numbers are rearranged in the respective symbol display frames W1, W2 and W3 of the liquid crystal panel 5B.

The second lottery program is a program used to determine the code numbers of the respective mini reels M1, M2 and M3 that correspond to each of the payout amounts rearranged in the respective payout amount display frames Q1, Q2 and Q3 of the liquid crystal panel 5B. Then, in the lottery program, it is included weighing data corresponding to each of plural kinds of payout rates (for example, 80%, 84%, and 88%). The weighing data are the data indicating correlation between the code number of each mini reel M1, M2 and M3 and one or plural random numbers belonging to a predetermined number range (0 to 255), every each of the three mini reels M1, M2 and M3. In other words, each of the code number of one mini reel M1, M2 and M3 is associated with one or more random numbers corresponding to the payout rate. The random numbers are extracted by the lottery program, and the payout amounts specified finally by the random numbers are rearranged in the respective payout amount display frames Q1, Q2 and Q3 of the liquid crystal panel 5B.

Random numbers over a predetermined range are generated by the random number generation circuit 35, which is operated based on instructions from the main CPU 32. The random numbers are voluntarily extracted from the random numbers generated by the random number generation circuit 35 by the sampling circuit 36, based on instructions from the main CPU 32, and the extracted random numbers are input to the main CPU 32. The base clock for running the main CPU 32 is generated by the clock pulse generation circuit 37, and signals which are generated by dividing the base clock in a predetermined frequency are input to the main CPU 32 by the frequency divider 38.

And to the main control board 71, the touch panel 101 is connected. The touch panel 101 is arranged in front of the liquid crystal panel 5B, and specifies the coordinate position of the portion touched by a player. The position on which a player touched and the direction of the movement of the touched portion are determined based on the specified coordinate position information. A signal corresponding to the determination is input to the main CPU 32 through the I/O port 39.

Also, the operation buttons 11 for instructing an execution of a game are connected to the main control board 71. The operation buttons 11 include the spin button, the collecting button and the BET button and the like. A signal corresponding to the depressing of these buttons is input to the main CPU 32 through the I/O port 39.

A ticket printer 14, a reader/writer 15, a coin sensor 21 and a bill sensor 22 are connected to the main control board 71. The reader/writer 15 reads information from an IC card and writes information in an IC card. The ticket printer 14 prints tickets with bar codes. The bill sensor 22 detects a bill inserted to the bill slot 13 one by one and sends a signal corresponding to the detection to the main CPU 32 via the I/O port 39. The coin sensor 21 detects a coin inserted to the coin slot 12 one by one and sends a signal corresponding to the detection to the main CPU 32 via the I/O port 39.

An effect signal which is used to conduct illumination effect is output to the above-mentioned light emitting portions 20 and the topper effect device 28 by the illumination effect driving circuit 61. Then, the topper effect device 28 is serially connected to the illumination effect driving circuit 61 through the light emitting portions 20.

A hopper 64 is driven by the hopper driving circuit 63 based on control of main CPU 32. The hopper 64 executes payout of coins, and coins are paid out from the coin tray 16. Data of the number of coins are input from the connected coin detecting portion 66 by the payout completion signal circuit 65. When the number of coins becomes a predetermined number, a signal indicating completion of the coins is input to the main CPU 32. The number of the coins paid out from the hopper 64 is calculated by the coin detecting portion 66, and the data of the number calculated are input to the payout completion signal circuit 65. The each display operation of the bet amount display portion 7, payout amount display portion 8 and credit amount display portion 9 is controlled by the display portion driving circuit 67.

Furthermore, a sub control board 72 is connected to the main control board 71. The sub control board 72 is connected to the liquid crystal panel 5A, the liquid crystal panel 5B and the speakers 23.

FIG. 6 is a block diagram showing an internal construction of the sub control board 72. As shown in FIG. 6, a command from the main control board 71 is input to the sub control board 72. The display control on the liquid crystal panel 5A of the upper display portion 4A and the liquid crystal panel 5B of the variable display portion 4B, and the sound output control on the speaker 23 are executed by the sub control board 72. The sub control board 72 is constructed on a circuit board different from the circuit board for the main control board 71, and includes a microcomputer 73 (abbreviated as “sub-microcomputer” hereinafter) as a main construction element, and a sound source IC 78, a power amplifier 79 and an image control circuit 81. The sound source IC 78 controls the sound output from the speakers 23, the power amplifier 79 is used as an amplification device, and the image control circuit 81 runs as a display control device of the liquid crystal panel 5A and 5B.

The sub-microcomputer 73 includes a sub CPU 74, a program ROM 75, a work RAM 76, an IN port 77 and an OUT port 80. The control operations are executed by the sub CPU 74 based on a control order sent from the main control board 71, the program ROM 75 is used as a memory device. Although a clock pulse generation circuit, a frequency divider, a random number generation circuit and a sampling circuit are not included in the sub control board 72, the sub control board 72 is constructed so as to execute random number sampling according to operation programs thereof. Control programs executed by the sub CPU 74 are stored in the program ROM 75. The work RAM 76 is constructed as a temporary storing device when the above control programs are executed by the sub CPU 74.

The image control circuit 81 includes an image control CPU 82, an image control work RAM 83, an image control program ROM 84, an IN port 85, an image ROM 86, a video RAM 87 and an image control IC 88. Images displayed on the liquid crystal panel 5A and 5B are determined by the image control CPU 82, based on parameters set by the sub-microcomputer 73, according to image control programs stored in the image control program ROM 84.

The image control programs regarding to a display of the liquid crystal panel 5A, 5B and a variety of selection tables are stored in the image control program ROM 84. The image control work RAM 83 is constructed as a temporary storing device when the image control programs are executed by the image control CPU 82. Images corresponding to contents determined by the image control CPU 82 are formed by the image control IC 88, and are output to the liquid crystal panel 5A, 5B.

In the image ROM 86, dot data used to form images are stored. Thus, it stores the dot data on symbols drawn on the reel band of the each video reel R1, R2 and R3 and the dot data on the payout amounts drawn on the reel band of the each mini reel M1, M2 and M3. The video RAM 87 runs as a temporary storing device when the images are formed by the image control IC 88.

Further, based on a control signal from the main CPU 32, the image control circuit 81 performs display control of scrolling display/stop display of the video reels R1, R2 and R3 in the respective symbol display frames W1, W2 and W3 of the liquid crystal panel 5B. In addition, based on a control signal from the main CPU 32, the image control circuit 81 performs display control of scrolling display/stop display of the mini reels M1, M2 and M3 in the respective payout amount display frames Q1, Q2 and Q3 of the liquid crystal panel 5B.

### 6. General Description of a Slot Game

Next, the payout amount when a slot game is executed in the slot machine 1 according to the present embodiment employing the video reels R1, R2 and R3 will be explained.

The symbol of “FRANKENSTEIN” is the payout trigger symbol. That is, only when the symbol of “FRANKENSTEIN” is rearranged in each symbol display frame W1, W2 and W3 of the liquid crystal panel 5B while a slot game is executed, a payout is awarded to a player. An amount of the payout corresponds to a total amount of the payout amounts which are rearranged in the payout amount display frames Q1, Q2 and Q3 on the liquid crystal panel 5B, respectively.

Here, the total amount indicates the payout amount when the bet amount is “1”. Therefore, when the bet amount is “1”, the total amount is paid out, and when the bet amount is more than “2”, the payout amount obtained by multiplying the total amount by the bet amount is paid out.

Therefore, on the liquid crystal panel 5B, for example, when “50” is rearranged in the payout amount display frame Q1, and “1” is rearranged in the payout amount display frame Q2, and “100” is rearranged in the payout amount display frame Q3, an amount obtained by multiplying “151”, which is a total amount of the payout amounts rearranged in the payout amount display frames Q1, Q2 and Q3, by the bet amount will be paid out.

Incidentally, if the symbol of “FRANKENSTEIN” is not rearranged in any one of the symbol display frames W1, W2 and W3 of the liquid crystal panel 5B, a player has lost and no payout for losing is made.

As mentioned above, in the slot machine 1 according to the present embodiment, a slot game is executed.

In other words, in a slot game, the slot game is executed by rearranging the symbol of “FRANKENSTEIN” by three video reels R1, R2 and R3 in the symbol display frames W1, W2 and W3 of the liquid crystal panel 5B. In the slot game, firstly, a part of symbol column (one symbol) drawn on the reel band of each video reel R1, R2 and R3 (shown in FIG. 3), is arranged in each symbol display frame W1, W2 and W3 of the liquid crystal panel 5B (refer to FIG. 7). Here, after a player sets the bet amount by depressing the BET button among the operation buttons 11, if the player depresses the spin button among the operation buttons 11, each of the video reels R1, R2 and R3 rotates, the symbol column drawn on the reel band of each video reel R1, R2 and R3 shown in FIG. 3, is scrolled from up to down in the symbol display frames W1, W2 and W3 of the liquid crystal panel 5B (refer to FIG. 8).

After a predetermined time, each of the video reels R1, R2 and R3 stops automatically, a part of symbol column (one symbol) drawn on the reel band of each video reel R1, R2 and R3 shown in FIG. 3, is rearranged in each symbol display frame W1, W2 and W3 of the liquid crystal panel 5B (refer to FIG. 7).

Then, as shown on the liquid crystal panel 5B shown on both sides in the upper stage of FIG. 1 above, when the symbol of “FRANKENSTEIN” is rearranged in each of the symbol display frames W1, W2 and W3, respectively, each mini reel M1, M2 and M3 is automatically displayed by a scrolling manner after a predetermined time has passed. Therefore, the column of the payout amounts drawn on the reel band of each mini reel M1, M2 and M3 shown in FIG. 4 is scrolled from up to down in each payout amount display frame Q1, Q2 and Q3, regardless of whether a player has depressed the operation button 11 such as the BET button or the spin button.

After a predetermined time has further passed, each mini reel M1, M2 and M3 is automatically displayed by a stopped manner as shown on the liquid crystal panel 5B shown on the right side in the middle stage of FIG. 1 above. Therefore, a part (one payout amount) of the column of the payout amounts drawn on the reel band of each mini reel M1, M2 and M3 shown in FIG. 4 is rearranged in each payout amount display frame Q1, Q2 and Q3 (refer to the right side in the middle stage of FIG. 1).

Then, as shown on the liquid crystal panel 5B shown on both sides in the middle stage of FIG. 1 above, each payout amount display frame Q1, Q2 and Q3 is displayed being enlarged to fit into a size of each symbol display frame W1, W2 and W3, respectively. Accordingly, the payout amount rearranged in each payout amount display frame Q1, Q2 and Q3 is displayed being enlarged.

Further, as shown on the liquid crystal panel 5B shown on the left side in the middle stage of FIG. 1, a total amount of the payout amounts rearranged in the payout amount display frames Q1, Q2 and Q3 of the liquid crystal panel 5B is computed. Then, as shown on the liquid crystal panel 5B shown on the left side in the lower stage of FIG. 1 above, a payout amount obtained by multiplying the computed total amount by the bet amount will be awarded to a player.

### 7. Operation of the Slot Machine

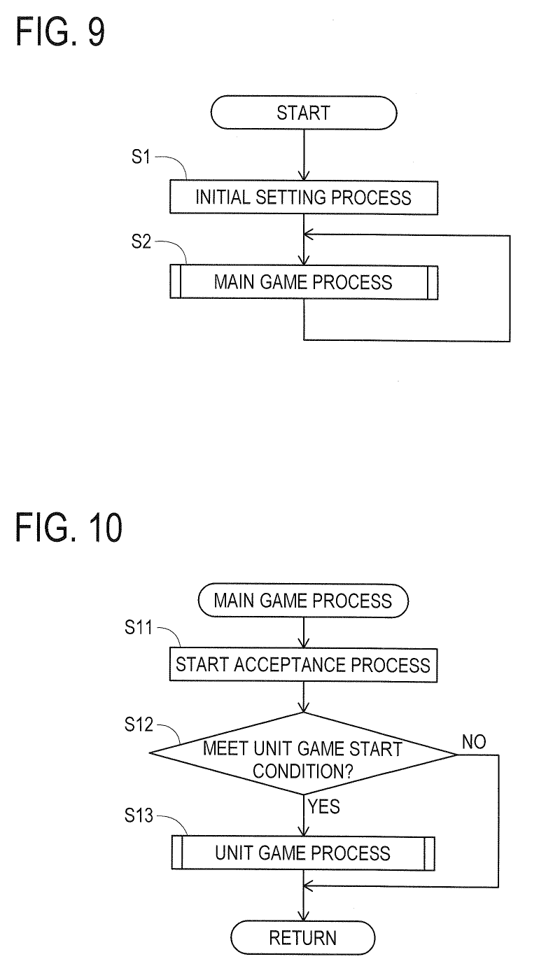

Next, a main control program executed in the slot machine 1 according to the present embodiment will be explained with reference to drawings. FIG. 9 is a flowchart of the main control program.

First, when a power switch is pressed (power activation), the microcomputer 31 is started to operate, an initial setting process is executed by the microcomputer 31 in step (abbreviated as “S”) 1. In the initial setting process, BIOS stored in the ROM 34 is executed by the main CPU 32. Compressed data included in the BIOS are expanded to the RAM 33, and when the BIOS expansion to the RAM 33 is executed, a diagnosing process and initialization process of various peripheral devices are executed. Also, the game programs and the like are written from the ROM 34 to the RAM 33 by the main CPU 32, so as to obtain the payout rate setting data and country ID information. Also, during execution of the initial setting process, a verification process to each program is executed.

Then in S2, the main CPU 32 reads out the game programs and the like from the RAM 33, and executes the programs in sequence so as to conduct the main game process. A game is executed in the slot machine 1 according to the present embodiment by executing the main game process. Then, the main game process is repeated when the power is supplied to the slot machine 1.

Next, a sub process of the main game process in S2 above will be explained with reference to FIG. 10. FIG. 10 is a flowchart of the main game process program in the slot machine 1 according to the present embodiment. Incidentally, each program shown in the flowchart of FIG. 10 is stored in the ROM 34 or the RAM 33 of the slot machine 1, and is executed by the main CPU 32.

First, as shown in FIG. 10, a start acceptance process is executed by the main CPU 32 in S11. At this time, in the start acceptance process, an insertion of coins or a bet operation using the BET button among the operation buttons 11 is executed by a player.

Then, in S12, the main CPU 32 determines whether or not unit game start conditions are met. Here, the unit game start conditions are that the spin button among the operation buttons 11 is depressed. Accordingly, this determination is made based on a signal which is input to the main CPU 32 depending on depressing the operation buttons 11. At this point, if the spin button among the operation buttons 11 is not depressed (S12: NO), the process returns to the start acceptance process (S11) again. Thereby, an operation of changing the bet amount and the like are possible. In contrast, if the spin button among the operation buttons 11 is depressed (S12: YES), the bet amount set based on the above bet operation is reduced from the credit amount owned by the player at the moment, and is stored in the RAM 33 as bet information. Incidentally, the credit amount after the reduction is also stored in the RAM 33 as credit information. Then, by sending a control signal to the display portion driving circuit 67, the main CPU 32 displays the credit information stored in the RAM 33 (the credit amount after the above reduction) on the credit amount display portion 9 of the liquid crystal panel 5B.

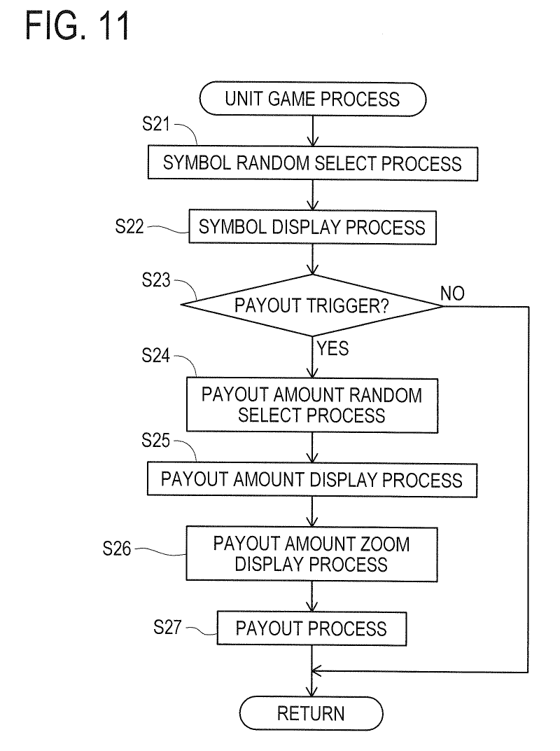

Then, when the process proceeds to S13, the main CPU 32 executes a unit game process. So, a sub process of the unit game process will be explained based on FIG. 11. FIG. 11 is a flowchart of the sub process of the unit game process program in the slot machine 1 according to the present embodiment. Incidentally, a program shown in the flowchart of FIG. 11 is stored in the ROM 34 or the RAM 33 of the slot machine 1, and is executed by the main CPU 32.

First, in the unit game process of S13 above, as shown in FIG. 11, the main CPU 32 executes a symbol random select process in S21. Specifically, when the first lottery program included in the game programs is executed by the main CPU 32, the random number corresponding to each video reel R1, R2 and R3 respectively is selected from a range of “0 to 255”. Then, with reference to the symbol weighting data corresponding to the payout rate setting data, based on the three random numbers, the code number of each video reel R1, R2 and R3 is determined by the main CPU 32. The main CPU 32 stores the determined code number of each video reel R1, R2 and R3 in the RAM 33 by overwriting code number information for symbol in the RAM 33 with the determined code number of each video reel R1, R2 and R3 so as to correspond to each symbol display frame W1, W2 and W3 of the liquid crystal panel 5B. Thereafter, the process proceeds to S22.

Here, the code number of each video reel R1, R2 and R3 is associated with the symbol number to be rearranged in each symbol display frame W1, W2 and W3 of the liquid crystal panel 5B, so each symbol to be rearranged in such game is determined by overwriting the code number information for symbol in the RAM 33 with the code number of each video reel R1, R2 and R3 determined by the main CPU 32 so as to correspond to each symbol display frame W1, W2 and W3 of the liquid crystal panel 5B. For example, if the main CPU 32 determines that all of the code number of each video reel R1, R2 and R3 are “21” and then overwrites the code number information for symbol in the RAM 33 with the code number of each video reel R1, R2 and R3 so as to correspond to each symbol display frame W1, W2 and W3 of the liquid crystal panel 5B, the main CPU 32 determines to rearrange the three symbols of “FRANKENSTEIN” (refer to FIG. 3). Thus, by overwriting the code number information for symbol in the RAM 33 with the code number of each video reel R1, R2 and R3 selected by a lottery so as to correspond to each symbol display frame W1, W2 and W3 of the liquid crystal panel 5B, each symbol to be rearranged in a unit game of a slot game is determined.

Subsequently, when proceeding to S22, the main CPU 32 executes a symbol display process. In other words, by sending a control signal to the sub control board 72, the main CPU 32 starts a scrolling display of each video reel R1, R2 and R3 in each symbol display frame W1, W2 and W3 of the liquid crystal panel 5B. After that, an effect mode (a display mode of images on the liquid crystal panel 5B and a sound output mode from the speakers 23) for each unit game is determined by the main CPU 32, and the sub control board 72 is ordered to start the effect in a predetermined effect pattern. Then, when a predetermined timing to stop displaying each video reel R1, R2 and R3 in scrolling manner comes, the main CPU 32, by sending a control signal to the sub control board 72, stops scrolling of each video reel R1, R2 and R3 being displayed. The stop operation is based on the code number stored in the RAM 33 by overwriting the code number information for symbol in the RAM 33 with the code number so as to correspond to each symbol display frame W1, W2 and W3 of the liquid crystal panel 5B. With this, each symbol which determined in S21 above-mentioned is rearranged in each symbol display frame W1, W2 and W3 of the liquid crystal panel 5B.

After that, when proceeding to S23, the main CPU 32 determines whether or not the payout trigger symbol is realized. Here, when the symbol of “FRANKENSTEIN” is rearranged in each symbol display frame W1, W2 and W3 of the liquid crystal panel 5B respectively, it is determined that the payout trigger symbol is realized. Therefore, the determination is made based on the code number in the RAM 33 by overwriting the code number information for symbol in the RAM 33 with the code number so as to correspond to each symbol display frame W1, W2 and W3 of the liquid crystal panel 5B. At this point, if the payout trigger symbol is not realized (S23: NO), the process returns to the start acceptance process (S11) in the above-mentioned main game process of FIG. 10 above. In contrast, if the payout trigger symbol is realized (S23: YES), the process proceeds to S24.

In S24, the main CPU 32 executes a payout amount random select process. Specifically, when the second lottery program included in the game programs is executed by the main CPU 32, the random number corresponding to each mini reel M1, M2 and M3 respectively is selected from a range of “0 to 255”. Then, with reference to the weighting data corresponding to the payout rate setting data, based on the three random numbers, the code number of each mini reel M1, M2 and M3 is determined by the main CPU 32. The main CPU 32 stores the determined code number of each mini reel M1, M2 and M3 by overwriting code number information for payout amount in the RAM 33 with the determined code number of each mini reel M1, M2 and M3 so as to correspond to each payout amount display frame Q1, Q2 and Q3 of the liquid crystal panel 5B. Thereafter, the process proceeds to S25.

Here, the code number of each mini reel M1, M2 and M3 is associated with the payout number to be rearranged in each payout amount display frame Q1, Q2 and Q3 of the liquid crystal panel 5B, so each of the payout amounts to be rearranged in such game is determined by overwriting the code number information for payout amount in the RAM 33 with the code number of each mini reel M1, M2 and M3 determined by the main CPU 32 so as to correspond to each payout amount display frame Q1, Q2 and Q3 of the liquid crystal panel 5B. For example, if the main CPU 32 determines that all of the code number of each mini reel M1, M2 and M3 are “21” and then overwrites the code number information for payout amount in the RAM 33 with the code number of each mini reel M1, M2 and M3 so as to correspond to each payout amount display frame Q1, Q2 and Q3 of the liquid crystal panel 5B, the main CPU 32 determines to rearrange the three payout amounts of “100” (refer to FIG. 4). Thus, by overwriting the code number information for payout amount in the RAM 33 with the code number of each mini reel M1, M2 and M3 selected by a lottery so as to correspond to each payout amount display frame Q1, Q2 and Q3 of the liquid crystal panel 5B, each payout amount to be rearranged in a unit game of a slot game is determined.

Subsequently, when proceeding to S25, the main CPU 32 executes a payout amount display process. In other words, by sending a control signal to the sub control board 72, the main CPU 32 starts a scrolling display of each mini reel M1, M2 and M3 in each payout amount display frame Q1, Q2 and Q3 of the liquid crystal panel 5B. After that, an effect mode (a display mode of images on the liquid crystal panel 5B and a sound output mode from the speakers 23) for each unit game is determined by the main CPU 32, and the sub control board 72 is ordered to start the effect in a predetermined effect pattern. Then, when a predetermined timing to stop displaying each mini reel M1, M2 and M3 in scrolling manner comes, the main CPU 32, by sending a control signal to the sub control board 72, stops scrolling of each mini reel M1, M2 and M3 being displayed. The stop operation is based on the code number stored in the RAM 33 by overwriting the code number information for payout amount in the RAM 33 with the code number so as to correspond to each payout amount display frame Q1, Q2 and Q3 of the liquid crystal panel 5B. With this, each of the payout amounts that determined in S21 above-mentioned is rearranged in each payout amount display frame Q1, Q2 and Q3 of the liquid crystal panel 5B.

Then, the main CPU32 executes a payout amount zoom display process in S26. In this process, by sending a control signal to the sub control board 72, the main CPU32 executes the following display control.

Namely, as shown on the liquid crystal panel 5B shown on the both sides in the middle side of FIG. 1 above, each payout amount display frame Q1, Q2 and Q3 is displayed being enlarged to fit into a size of each symbol display frame W1, W2 and W3. Accordingly, the payout amount rearranged in each payout amount display frame Q1, Q2 and Q3 is displayed being enlarged.

Further, the main CPU 32 computes a payout amount obtained by multiplying a total amount of the payout amounts rearranged in the payout amount display frames Q1, Q2 and Q3 of the liquid crystal panel 5B by the bet amount. Incidentally, the computation is executed based on the bet information in the RAM 33 and the code number information for payout amount. The computed payout amount is stored in RAM 33 as payout information. After that, by sending a control signal to the display portion driving circuit 67, the main CPU 32 displays the payout information stored in the RAM 33 (the above-mentioned computed amount) on the payout amount display portion 8 of the liquid crystal panel 5B.

Then, the main CPU 32 executes a payout process in S27. In the payout process, the payout amount awarded to a player in a slot game is paid out to the player based on the payout information stored in the RAM 33.

When the payout is executed, the credit amount stored in the RAM 33 as the payout information (the payout amount awarded to a player in a slot game) are added to the credit amount stored in the RAM 33 as the credit information, and the added value is overwritten in the RAM 33 as the credit information. After that, by sending a control signal to the display portion driving circuit 67, the main CPU 32 displays the credit information stored in the RAM 33 (the added value computed in S27) on the credit amount display portion 9 of the liquid crystal panel 5B. At the same time, the main CPU 32 overwrites “0” to the RAM 33 as the payout information, and displays “0” on the payout amount display portion 8 of the liquid crystal panel 5B by sending a control signal to the display portion driving circuit 67.

Incidentally, in the payout process, the credit amount owned by a player at the moment may be paid out by coins corresponding to the credit amount (one credit equals to one coin) based on the player's depressing the CASHOUT button among the operation buttons 11, or may also be paid out by a ticket with a bar code which is printed by the ticket printer 14.

Then, after the main CPU 32 executes the above-mentioned payout process in S27, the process returns to the start acceptance process (S11) in the above-mentioned main game process of FIG. 10 above.

### 8. Others

Incidentally, the present invention is not limited to the above embodiments, but various changes may be made without departing from its scope.

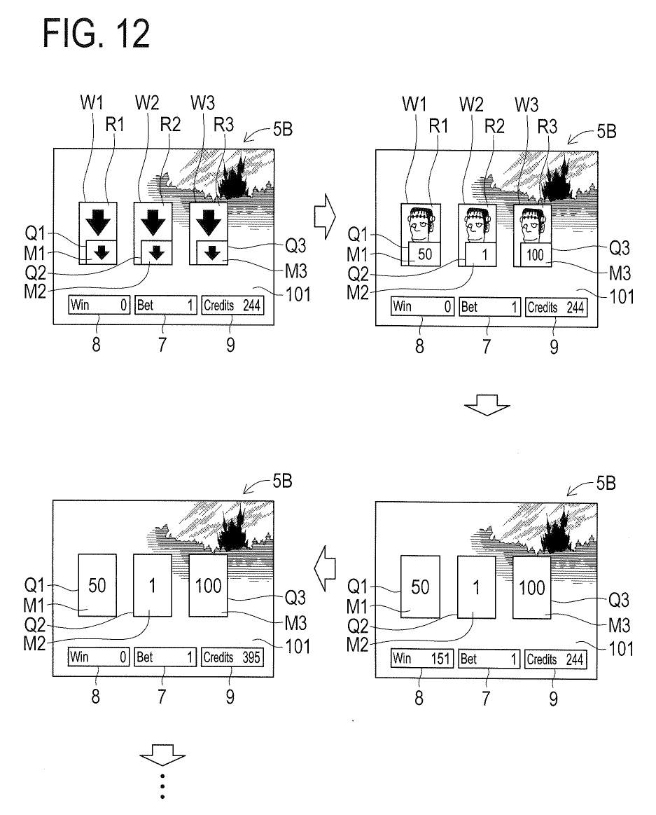

For example, as shown in FIG. 12, the payout amount may be rearranged in each payout amount display frame Q1, Q2 and Q3 of the liquid crystal panel 5B by each unit game of a slot game regardless of whether the symbol of “FRANKENSTEIN” is rearranged in each symbol display frame W1, W2 and W3 on the liquid crystal panel 5B.

In other words, as shown on the liquid crystal panel 5B shown on the left side in the upper stage of FIG. 12, when each video reel R1, R2 and R3 is rotated in the symbol display frames W1, W2 and W3, respectively, each mini reel M1, M2 and M3 is also displayed by a scrolling manner in the payout amount display frames Q1, Q2 and Q3.

When a predetermined time has further passed, as shown on the liquid crystal panel 5B shown on the right side in the upper stage of FIG. 12, each video reel R1, R2 and R3 automatically stops and each mini reel M1, M2 and M3 is automatically displayed in a stopped manner. Accordingly, one of the symbols drawn on the reel band of each video reel R1, R2 and R3 is rearranged in each symbol display frame W1, W2 and W3, respectively. Further, one of the payout amounts drawn on the reel band of each mini reel M1, M2 and M3 is rearranged in each payout amount display frame Q1, Q2 and Q3, respectively.

Here, as shown on the liquid crystal panel 5B shown on the right side in the upper stage of FIG. 12, when the symbol of “FRANKENSTEIN” is rearranged in each symbol display frame W1, W2 and W3, respectively, the following display control will be performed.

Namely, as shown on the liquid crystal panel 5B shown on the right side in the lower side of FIG. 12, each payout amount display frame Q1, Q2 and Q3 is displayed being enlarged to fit into a size of each symbol display frame W1, W2 and W3. Accordingly, the payout amount rearranged in each payout amount display frame Q1, Q2 and Q3 is displayed being enlarged. Further, a total amount of the payout amounts rearranged in the payout amount display frames Q1, Q2 and Q3 of the liquid crystal panel 5B is computed. A payout amount obtained by multiplying the total amount by the bet amount which is indicated by a player is displayed in the payout amount display portion 8. With this, the obtained payout amount will be awarded to the player. Incidentally, the bet amount which is indicated by the player is displayed in the bet amount display portion 7.

When the slot game is finished, the payout amount displayed in the payout amount display portion 8 is added to the amount in the credit amount display portion 9, and the added amount is displayed in the credit amount display portion 9, as shown on the liquid crystal panel 5B shown on the left side in the lower stage of FIG. 1.

Therefore, also in this case, only in a unit game in which the symbol of “FRANKENSTEIN” is rearranged in each symbol display frame W1, W2 and W3 of the liquid crystal panel 5B, respectively, a total amount of the payout amounts rearranged in the payout amount display frames Q1, Q2 and Q3 of the liquid crystal panel 5B is computed. A payout amount obtained by multiplying the computed total amount by the bet amount will be awarded to the player.

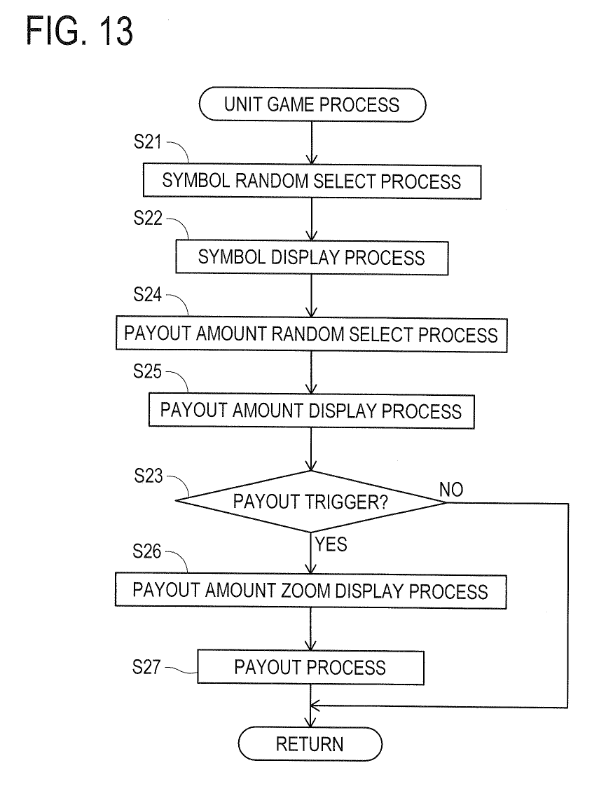

For executing such a slot game, the main CPU 32 executes a unit game process program shown in FIG. 13 instead of the unit game process program shown in FIG. 11. Compared to the unit game process program shown in FIG. 11, the unit game process program shown in FIG. 13 is different in that the processes of S24 and S25 are executed prior to the process of S23. Other processes are the same in the unit game process program shown in FIG. 13 and the unit game process program shown in FIG. 11, so detailed explanation will be omitted.

What is claimed is:

1. A slot machine comprising:
a plurality of payout trigger symbols;
a plurality of symbols including the payout trigger symbols;
a symbol group comprising the symbols;
a plurality of symbol frames in each of which one of the symbols is arranged;
a display device for displaying each of the symbol frames;
a plurality of payout amount frames being superimposed on a part of each of the symbol frames which is displayed on the display device, a payout amount being arranged in each of the payout amount frames;
a unit game in which a payout amount is awarded to a player when all the symbols displayed on the display device are the payout trigger symbols;
an input device with which a player performs a betting operation for the unit game; and
a processor programmed, for repeating the unit game repeatedly, to execute each of processes from the process of (1) below to the process of (7) below:
(1) selecting some of the symbols at random from the symbol group upon completing a betting operation for a current unit game by a player using the input device;
(2) displaying on the display device each of the selected symbols being rearranged in each of the symbol frames;
(3) determining whether all the symbols displayed on the display device are the payout trigger symbols or not;
(4) returning to the process of (1) if it is determined that not all the symbols displayed on the display device are the payout trigger symbols;
(5) rearranging each payout amount in each of the payout amount frames if it is determined that all the symbols displayed on the display device are the payout trigger symbols;
(6) enlarging a size of each payout amount rearranged in each of the payout amount frames to a size of each of the symbol frames and displaying each of the enlarged payout amount on the display device; and
(7) awarding a total amount of the payout amounts that are rearranged in the payout amount frames to the player and returning to the process of (1).

2. The slot machine of claim 1, further comprising:
a payout amount group comprising a plurality of payout amounts, wherein
the processor is programmed to execute the process of (8) below in executing the process of (5) above:
(8) selecting each payout amount at random from the payout amount group so as to be rearranged in each of the payout amount frames.

3. A slot machine comprising:
a plurality of payout trigger symbols;
a plurality of symbols including the payout trigger symbols;
a symbol group comprising the symbols;
a plurality of symbol frames in each of which one of the symbols is arranged;
a display device for displaying each of the symbol frames;
a plurality of payout amount frames being superimposed on a part of each of the symbol frames which is displayed on the display device, a payout amount being arranged in each of the payout amount frames;
a unit game in which a payout amount is awarded to a player when all the symbols displayed on the display device are the payout trigger symbols;
an input device with which a player performs a betting operation for the unit game; and
a processor programmed, for repeating the unit game repeatedly, to execute each of processes from the process of (1) below to the process of (7) below:
(1) selecting some of the symbols at random from the symbol group upon completing a betting operation for a current unit game by a player using the input device;
(2) displaying on the display device each of the selected symbols being rearranged in each of the symbol frames and rearranging each payout amount in each of the payout amount frames;
(3) determining whether all the symbols displayed on the display device are the payout trigger symbols or not;
(4) returning to the process of (1) if it is determined that not all the symbols displayed on the display device are the payout trigger symbols;
(5) enlarging a size of each payout amount rearranged in each of the payout amount frames to a size of each of the symbol frames and displaying each of the enlarged payout amount on the display device if it is determined that all the symbols displayed on the display device are the payout trigger symbols; and
(6) awarding a total amount of the payout amounts that are rearranged in the payout amount frames to the player and returning to the process of (1).

4. The slot machine of claim 3, further comprising:
a payout amount group comprising a plurality of payout amounts, wherein
the processor is programmed to execute the process of (7) below in executing the process of (2) above:
(7) selecting each payout amount at random from the payout amount group so as to be rearranged in each of the payout amount frames.
